(19) United States
(12) Patent Application Publication
(10) Pub. No.: US 2012/0231853 A1
(43) Pub. Date: Sep. 13, 2012

(54) INFORMATION TERMINAL AND INPUT CONTROL PROGRAM

(75) Inventors: Hiroyuki Takahashi, Shinjuku-ku (JP); Shugo Takahashi, Shinjuku-ku (JP); Ayumu Shindo, Shinjuku-ku (JP)

(73) Assignee: CAMELOT CO., LTD., Shinjuku-ku, Tokyo (JP)

(21) Appl. No.: 13/508,642

(22) PCT Filed: Nov. 8, 2010
(86) PCT No.: PCT/JP2010/069800

§ 371 Date: May 8, 2012

(30) Foreign Application Priority Data
Nov. 9, 2009 (JP) 2009-256500

(51) Int. Cl. G06F 3/041; H04W 88/02; G06F 3/048; H04M 1/02

(52) U.S. Cl. 455/566

(57) ABSTRACT

In an information terminal such as a mobile phone, a movement function of a display screen is controlled in response to a type of user operation to prevent erroneous selection of selectable items and improve operability. The terminal is provided with a touch panel (300) to which an operation signal is inputted by pressure caused by a touch operation, an operation signal acquisition unit (200f) which detects a coordinate position of the operation signal that is inputted to the touch panel (300), an input range setting unit (200d) which partitions a plurality of input ranges on the touch panel (300), an operation signal analysis unit (200h) which acquires and analyzes a predetermined operation signal, and an operation mode switching unit (200g) which changes positions or areas of the respective input ranges upon the touch panel (300) on the basis of the result of the analysis from the operation signal analysis unit (200h).

### TECHNICAL FIELD

The present invention relates to an information terminal and an input control program, such as a cellular phone, etc., equipped with a touch panel for inputting manipulate signals by a pressure of a touch manipulation.

### BACKGROUND ART

In recent years, it has been increasing to equip a touch panel for an input manual operation within an information terminal, such as a cellular phone terminal and a portable information terminal (PDA). This type of the touch panel is provided with a touch sensor superposed on a display screen, and the touch sensor detects a contact position and determines whether a user manipulates buttons and icons on the screen by comparing this position and positions of buttons and icons displayed on the screen when the user applies pressure to the display screen with a finger or a pen.

Incidentally, in accordance with the information terminal as mentioned above, downsizing is expected, but along with rapid progress in multi-functionalization, such as transmission and reception of e-mails, the Internet connectivity, and camera photographing, etc., select options, such as many icons and files, are increasing, and things cannot be displayed on the display screen sometimes.

As opposed to this, an art disclosed by the patent literature 1 proposes that a user touches a touch panel of a display screen with a finger and moves relative position (up and down or sideways) to scroll option items on the display screen and to move option items that are not displayed on the display screen at first to be displayed on the display screen. According to such arts disclosed in the patent literature 1, it is possible to reduce a number of manipulations by button manipulations etc., to quickly display intended select options, and to select from them.

### PRIOR ART LITERATURE

### Patent Literature

[PATENT LITERATURE 1] Japanese Unexamined Patent Application Publication No. 2003-330613

### SUMMARY OF THE INVENTION

### Technical Problem

However, as for the art disclosed in the above mentioned PATENT LITERATURE 1, when one of the many select options displayed on the display screen is selected by the user's finger through the touch panel, other select options which are adjacent to the intended select option that the user tries to select are accidentally selected since display intervals and display areas of multiple select options are smaller than an area of a user's fingertip. In particular, when the intended select option that the user tries to select is displayed near a scroll bar, there is a problem that the scroll bar is accidentally selected and the select options disappear from the display screen.

Therefore, the present invention provides a user interface that can avoid accidentally selecting select options and improve operability within an information terminal, such as a cellular phone and a mobile terminal, having a touch panel, by controlling an input range on the touch panel according to manipulation contents of the user.

### Solution to Problem

In order to accomplish the object as described above, the present invention provides an information terminal having a touch panel for inputting manipulate signals with a pressure of a touch manipulation; a manipulate signal acquisition section for detecting a coordinate position of the manipulate signals input to the touch panel; an input range setting section for partitioning multiple input ranges on the touch panel; a manipulate signal analyzing section for acquiring and analyzing a specified manipulate signal; and a manipulate mode switching section for changing a position or size of each of the input range on the touch panel based on a analysis result by the manipulate signal analyzing section.

In addition, another invention provides an input control program for controlling input of manipulate signals against a touch panel within an information terminal having the touch panel for inputting the manipulate signals with a pressure of a touch manipulation, the input control program causing the information terminal to perform:

(1) an input range setting step for partitioning multiple input ranges onto the touch panel;

(2) a manipulate signal acquisition step for detecting a coordinate position of manipulate signals input to the touch panel;

(3) a manipulate signal analyzing step for acquiring and analyzing specified manipulate signals; and

(4) a manipulate mode switching step for changing a position or a size of each of the input range on the touch panel based on an analysis result by the manipulate signal acquisition step.

In accordance with these present inventions, since the input range is partitioned in the touch panel, the input information and the manipulation method can be split according to the partitions, and areas of the touch panel can be effectively utilized. At that time, by manipulating specified manipulation in a partition of either one of the partitions, it is possible to change the input information of each partitions and priority of the manipulation methods by changing locations or areas of the input range, and it is possible to easily change prior input information and manipulation method.

In the invention as described above, it is preferred that for analyzing the manipulate signals, it measures an input duration at a specified coordinate position; and for switching the manipulate mode, it changes the input range when an input duration measured by measuring the input time becomes a specified duration or an interval.

In this case, specified manipulate signals can be specified by the specified coordinate position, the input duration and the interval, for example long-pressing an arbitrary point on the touch panel and tapping, etc., and it is possible to implement changing the input information and the manipulation methods easily without providing a special device.

In the invention as described above, it is preferred that a first input range and a second input range are partitioned for setting the input range;
the first input range displays selectable select options as icons by touch manipulation and moving the icons according to a shift amount of the coordinate position of the manipulate signals at the first input range;
the second input range displays a total shift amount of the icons as a gauge, and the gauge is changed according to a shift amount of the coordinate position of the manipulate signals in the second input range; and for switching the manipulate mode, it is independent from a display range of the gauge and a display range of the icons, and a position and a size of the first input range and the second input range are changed

In this case, when the first and the second input range have a hierarchical relationship, it is possible to switch a hierarchy by specific switching manipulation. At this time, since the display range of the icons or the gauge are kept intact and a location and an area of the input range are changed independently from the display, malfunctions over the display range can be accepted and manipulations toward any input ranges can be given priority.

In the invention as described above, it is preferred that for setting the input range, the input range is split into multiple split screens, and the first input range and the second input range are partitioned as a pair within all or a part of the multiple split screens. In this case, it is possible to form multiple manipulate objects on one touch panel at the same time, and it is possible to achieve diversification as an interface.

In the invention as described above, it is preferred that the icons are arrayed in a spiral form, and shifted back and forth in a radial direction in accordance with a rotational transfer of the coordinate position of an input signal in the first input range or in accordance with a manipulated variable against the gauge in the second input range.

In this case, necessary information can be intensively presented in a limited display range such that the icons are arranged in a helical form within a virtual space and displayed in a so-called spiral form, which is two-dimensionally indicating them, and the icons are displayed zooming in and out its scaling such that zooming-out from the center to the outward, or zooming-in from the outside to the center by rotating manipulation of the user to form clockwise or counter-clockwise spiral. In particular, in this invention, a rotational manipulation that the user describes a circle with touched finger is manipulated in the first input range, and it is possible to switch shifting method of the icons because of a manipulation to change a gauge display in the second input range such that rotationally shifting the coordinate position of the input signal or sliding a point on the gauge; therefore, it is possible to improve operability.

In the invention as described above, it is preferred that the select options form a virtual hierarchical structure according to its type, a link is formed between the select options according to a mutual relevance, and it is possible to be shifted between hierarchies by following the link; and the icons are arranged in the spiral form according to the hierarchical structure or the link, and color-coded by hierarchies or coded to be displayed.

In this case, it is possible to organize with a virtual hierarchical structure when the select options are increased by multi-functionality of the information terminal and wide variety of icons are needed to be displayed, and it is possible to improve operability by presenting this hierarchical structure in the above mentioned spiral form.

### Advantageous Effects of Invention

In accordance with the present invention, it is possible to provide a user interface that can avoid accidentally selecting select options and improve operability within an information terminal, such as a cellular phone, etc., by controlling an input range on the touch panel according to manipulation contents of the user.

### BRIEF DESCRIPTION OF DRAWINGS

FIG. 1 is an outline view of the portable communication terminal 1 in accordance with the embodiment.

FIG. 2 is a block diagram showing the internal configuration of the portable communication terminal 1 in accordance with the embodiment.

FIG. 3 is a block diagram showing the internal configuration of input control of the portable communication terminal in accordance with the embodiment.

FIG. 4 is a flow chart illustrating processes of the input control in accordance with the embodiment.

FIG. 5 is an explanatory view illustrating a manipulation example of GUI (in vertical orientation) in accordance with the embodiment.

FIG. 6 is an explanatory view illustrating a manipulation example of GUI (in landscape orientation) in accordance with the embodiment.

FIG. 7 is an explanatory view illustrating a manipulation example of GUI (in a split screen) in accordance with the embodiment.

FIG. 8 is a schematic diagram conceptually illustrating a hierarchy structure of select options in accordance with the embodiment.

FIG. 9 is an explanatory view showing display example of focus in GUI in accordance with the embodiment.

FIG. 10 is an explanatory view showing display example of focus in GUI (for camera functions) in accordance with the embodiment.

### DESCRIPTION OF EMBODIMENTS

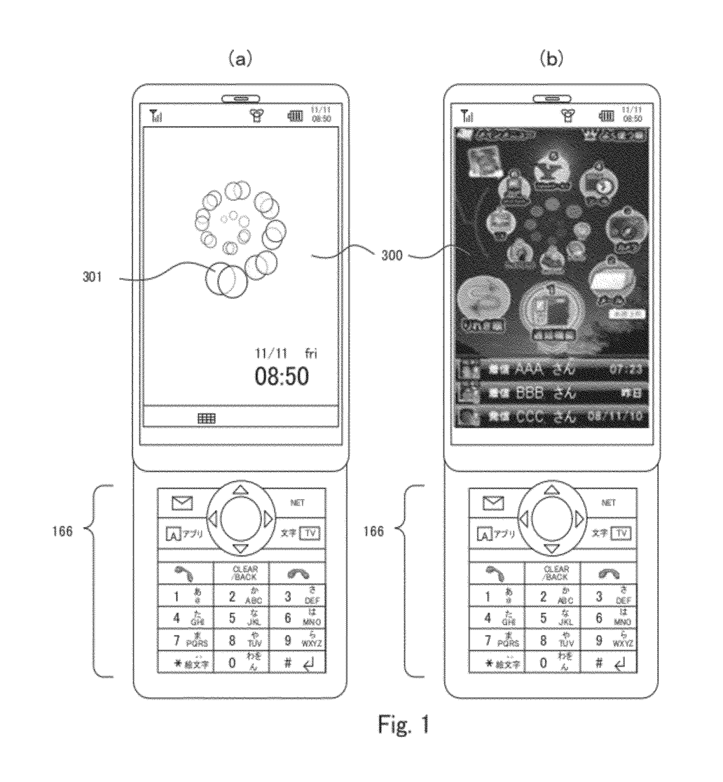

With reference to the accompanying drawing, an embodiment of an information terminal related to the present invention is described in detail in the following. FIG. 1 is an outline view of a portable communication terminal 1 in accordance with this embodiment. As shown in FIGS. 1(a) and (b), the portable communication terminal 1 is provided with a body 100 of rectangular shape, and a touch panel 300 is provided in a predetermined arrangement on a surface in a front side of the body 100.

(Description for Displaying and Manipulation of Touch Panel)

The touch panel 300 is an input device inputting manipulate signals with a pressure of a touch manipulation, touching with a finger of a user, a pen or the like, and is provided with and superposed on a LCD 165 which is displaying graphics and a touch sensor 168 which is receiving the manipulate signals corresponding to a coordinate position of the graphics displayed on the LCD 165. The portable communication terminal 1 of this embodiment is provided with a manual operation button 166, such as a button switch, an arrow key, and so forth, other than the touch panel 300, and it is possible to input the manipulate signals by using this manual operation button 166.

As shown in FIGS. 1(a) and (b), the touch panel 300 displays manipulation menu, select options selectable by a touch manipulation, as icons. The icons are arranged in a spiral form on a display screen which is displayed by the LCD 165, and the icons are provided to shift according to the touch manipulation. In detail, in accordance with this embodiment, by arranging multiple icons in a helical form within a virtual space and two-dimensionally indicating them, the icons are arrayed in a so-called spiral form. By rotating manipulation of the user toward the touch panel 300 to form clockwise or counter-clockwise spiral, icons are displayed zooming in and out its scaling such that zooming-out from the center to the outward, or zooming-in from the outside to the center.

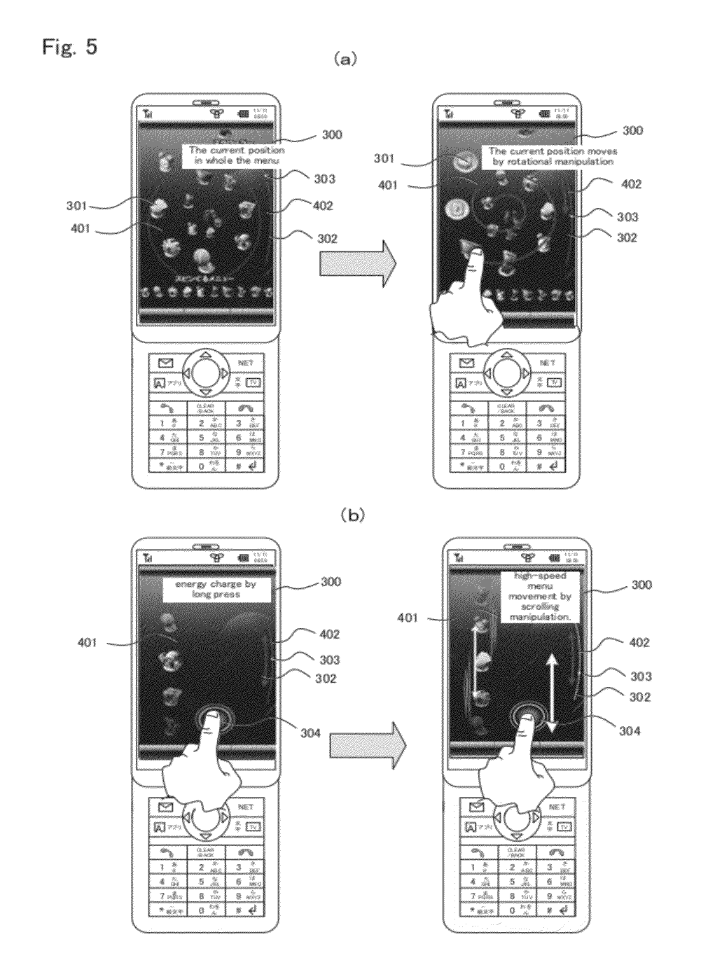

In addition, in accordance with the touch panel 300 of this embodiment, as shown in FIG. 5, the icons are arranged in the spiral form in a first input range 401, and a gauge is displayed in a second input range 402. Generally, the icons are shifted by rotational manipulation (“round-and-round manipulation”) on the first input range, and a present shift amount with respect to a total shift amount of the icons is displayed at a position of a point on the gauge.

When this round-and-round manipulation is detected, the display range of the icons and the gauge are kept intact, a proportion of the first and the second input range is changed, and entire touch panel 300 is set to the first input range. As a result, although the user touches the gauge during the round-and-round manipulation, the manipulation toward the gauge is ignored and malfunction may be avoided.

On the other hand, in accordance with either one of the first or the second input range, as shown in FIG. 5(b), when any one point is long pressed for a specified duration, the display range is kept intact, the second input range is zoom out, and the entire touch panel 300 is set to the second input range. This duration for long pressing is memory indication on the gauge, and a sufficient duration for switching the input range is indicated as if energy has been stored in an energy gauge.

As a result, it is possible to perform manipulations of the gauge at any place on the touch panel, and a point of the gauge is easily manipulated although a display of the gauge is small. In particular, since the duration for switching the input range is indicated at the energy gauge, sufficient duration can be visually verified and malfunctions can be avoided.

In this way, the first and the second input range can have a hierarchical relationship, and a hierarchy of the input range can easily be switched. At this time, since the display range of the icons or the gauge are kept intact and a location and an area of the input range are changed independently from the display, malfunctions over the display range can be accepted and manipulations toward any input ranges can be given priority.

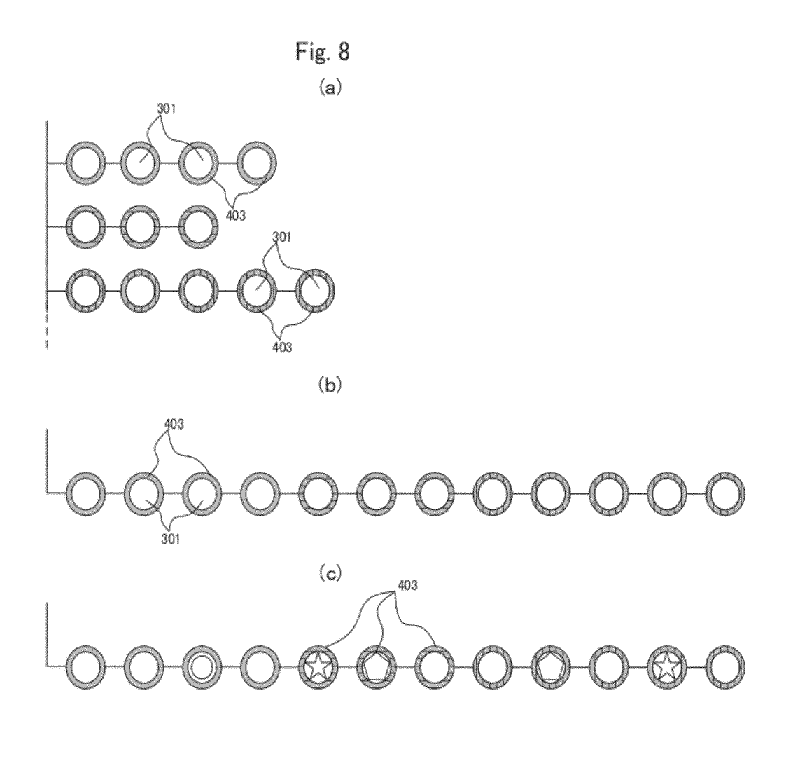

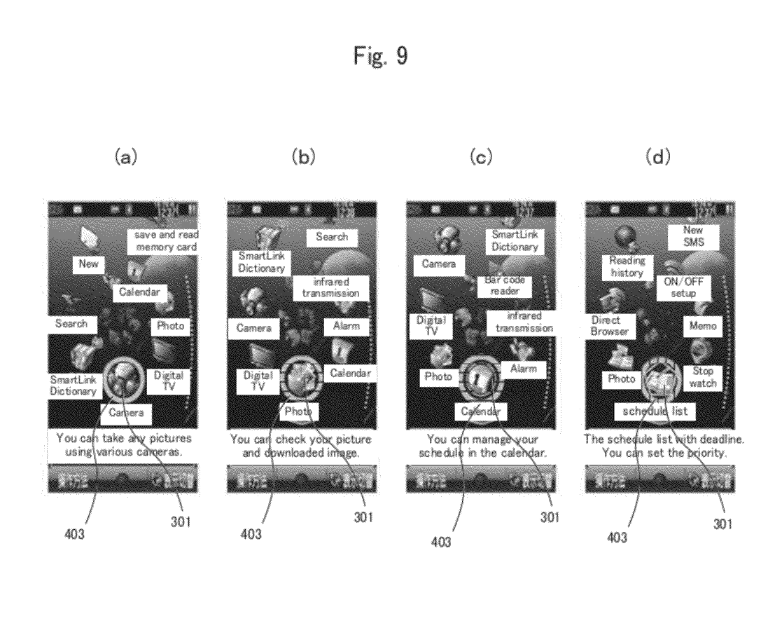

Moreover, in accordance with this embodiment, the above mentioned select options, as shown in FIG. 8(a), it forms a virtual hierarchical structure according to its type, a link is formed between the select options according to a mutual relevance, and it is possible to be shifted between hierarchies by following the link. In addition, in accordance with the above mentioned second input range, as shown in FIGS. 8(b) and (c), the icons are arranged in the hierarchical structure or linearly arranged according to the link, arrayed in the spiral form, and color-coded by hierarchies (FIG. 8(b) or coded (FIG. 8(c)) to be displayed. This color-coding and coding may be performed against all icons displayed on the display, and as shown in FIG. 9, it may also be formed to change colors and forms of the focus 403 according to the hierarchy of the icons, alternative options located in the focus 403.

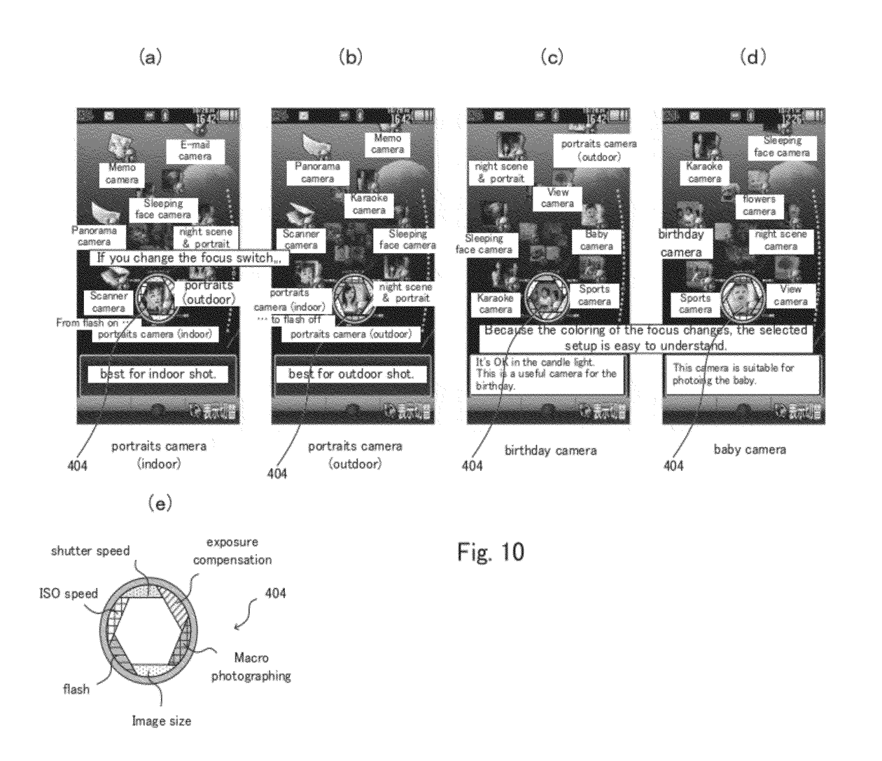

Furthermore, when the select options are related to camera functions, this focus indication may be a focus 404 designed like a camera shutter, as shown in FIG. 10(a) through (d). In accordance with this focus 404, as enlarged and shown in FIG. 10(e), settings of a shutter speed, an exposure compensation, and other camera functions are indicated by colors and figures. In addition, as shown in FIG. 10(a) through (d), settings according to situations at photographing, such as “portraits camera” suitable for taking indoors and outdoors pictures of people, “birthday camera,” “baby camera,” and etc., or types of subject are indicated by colors of the shutter or changes of the figures so that users may visually perceive camera settings.

(Internal Configuration of Portable Communication Terminal)

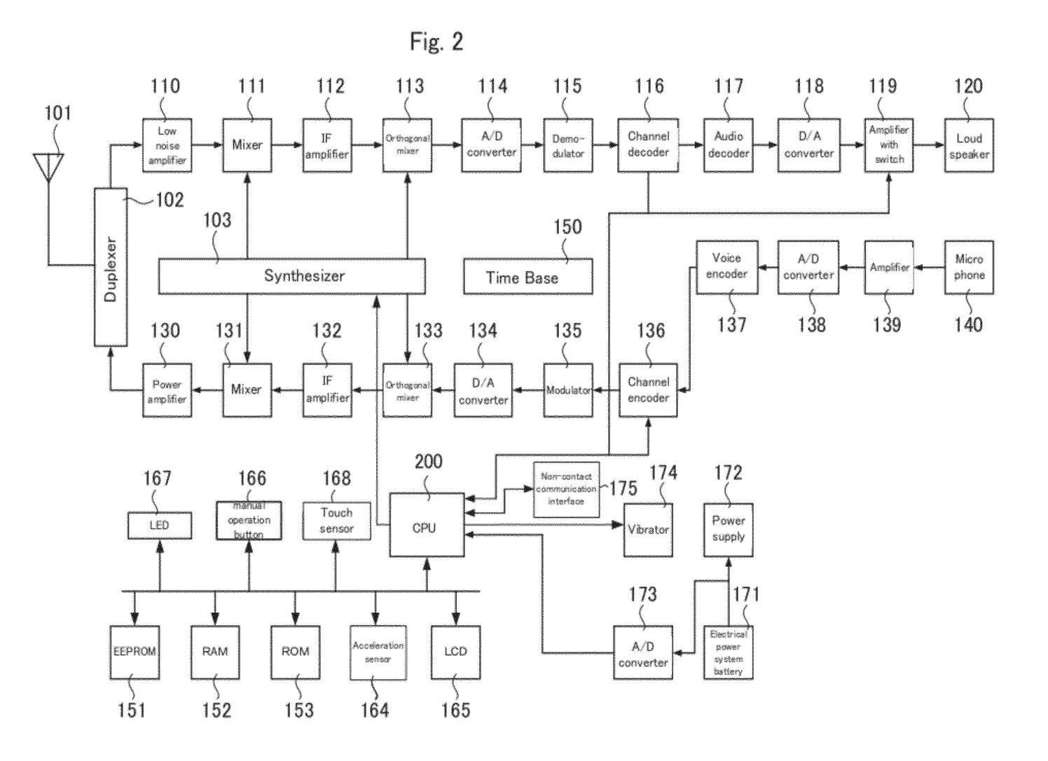

The following is a detailed explanation for a specific internal configuration of the portable communication terminal 1, described above, having a displayable and manipulatable touch panel. FIG. 2 is the block diagram showing the internal configuration of the portable communication terminal 1 related to this embodiment. As shown in the figure, the portable communication terminal 1 is provided with a duplexer 102 connected to an antenna 101, and the receiving system module and transmission system module which were connected to this duplexer 102.

As for the receiving system module, it has a low noise amplifier 110, a mixer 111, an IF amplifier 112, an orthogonal mixer 113, an A/D converter 114, a demodulator 115, a channel decoder 116, an audio decoder 117, a D/A converter 118, an amplifier 119 with a switch and a loudspeaker 120. On the other hand, as a transmission system module, it has a microphone 140, an amplifier 139, an A/D converter 138, a voice encoder 137, a channel encoder 136, a modulator 135, a D/A converter 134, an orthogonal mixer 133, an IF amplifier 132, a mixer 131, and a power amplifier 130.

The portable communication terminal 1 is provided with a synthesizer 103, a time base 150, a CPU 200, a RAM 152, a ROM 153, and an EEPROM 151 as a control system module, is provided with an acceleration sensor 164, an LCD 165, a manual operation button 166, an LED 167, a touch sensor 168, and a vibrator 174 as a user interface system module, and is provided with an electrical power system battery 171, a power supply 172, and an A/D converter 173 as an electrical power system module.

The antenna 101 transmits and receives a signal to abase station (not shown) via an electric wave line. The duplexer 102 is a circuit which changes input and output of the signal transmitted and received, inputs into the low noise amplifier 110 the signal which the antenna 101 received, and outputs the signal outputted from the power amplifier 130 to the antenna 101.

In the receiving system module, the low noise amplifier 110 amplifies the signal inputted from the duplexer 102, and outputs it to the mixer 111. The mixer 111 undergoes the output of the low noise amplifier 110, separates only specific frequency, and is outputted as an intermediate frequency signal. The IF amplifier 112 amplifies the intermediate frequency signal outputted from the mixer 111. The orthogonal mixer 113 undergoes and carries out orthogonal demodulation of the output of the IF amplifier 112. The A/D converter 114 digitizes the output of the orthogonal mixer 113. The demodulator 115 restores to the output of the A/D converter 114. The channel decoder 116 carries error correction to the output of the demodulator 115. The control message and voice data are contained in the signal which carried error correction. The control message is sent out to the CPU 200 and voice data is sent out to the audio decoder 117.

The signal inputted into the audio decoder 117 from the channel decoder 116 is decoded by voice data, and is delivered to the D/A converter 118. The D/A converter 118 changes the output of the audio decoder 117 into the analog signal. The amplifier 119 with the switch is changed to suitable timing based on the control signal from the CPU 200, and amplifies the output of the D/A converter 118 in the state of the switch ON. The loudspeaker 120 amplifies the output of the amplifier 119 with the switch.

On the other hand, in the transmission system module, the microphone 140 receives the audio signal from the user, and outputs this audio signal as an analog signal. The amplifier 139 amplifies the analog signal outputted from the microphone 140. The A/D converter 138 changes the output of the amplifier 139 into the digital signal. The voice encoder 137 codes and curtails the output of the A/D converter 138, and outputs it as voice data. The channel encoder 136 combines the control message from CPU 200 with a voice data from the voice encoder 137 and adds the error correcting code.

In addition, the modulator 135 modulates the output of the channel encoder 136. The D/A converter 134 changes the output of the modulator 135 into an analog signal. The orthogonal mixer 133 changes the output of the D/A converter 134 into the IF frequency signal (intermediate frequency signal). The IF amplifier 132 amplifies the output of the orthogonal mixer 133. The mixer 131 raises the frequency of the signal which IF amplifier 132 outputs. The power amplifier 130 amplifies the output of the mixer 131.

The synthesizer 103 takes the synchronization of the mixer 111, the orthogonal mixer 113, the mixer 131, and the orthogonal mixer 133 during communication. The time base 150 supplies the clock signal to each part.

In the user interface system, the acceleration sensor 164 is the sensor which detects a value and a direction of acceleration. The LCD 165 is a liquid crystal display on which the user is made to display the message, the input character, etc. In GUI on the touch panel 300, graphics, such as characters, figures and videos (movies), can be displayed via this LCD 165, and the manipulate signal is acquired through the touch sensor 168 on the touch panel 300.

The LED 167 is for telling the user the message by lighting and putting out lights. The touch sensor 168 detects that the user's finger contacted the touch panel surface, and inputs the manipulate signal with a pressure to the touch panel 300 surface. The vibrator 174 is a device which informs mail arrival, and when it receives a message, it will vibrate.

The electrical power system battery 171 supplies electric power to the power supply 172 and the A/D converter 173. The power supply 172 is a power supply of the portable communication terminal 1. The A/D converter 173 supplies a signal to the CPU 200.

The CPU 200 is an processing unit which controls each section of the above, carries out sequential execution of the command of the program stored in ROM 153, and performs the various functions. The RAM 152 is used as a working memory of the CPU 200, etc. and stores the result of an operation by the CPU 200 temporarily. The program for the CPU 200 is recorded on the ROM 153 and the executive instruction of the program is outputted one by one with the request from the CPU 200. The user data, IDs indigenous on the body, and the telephone numbers, such as the abbreviated dialing, are recorded on the EEPROM 151.

In addition, as for this embodiment, the CPU 200 works as an application execution section 200b to execute applications, and various modules are virtually built on the CPU 200 by executing software, such as the input control program of the present invention, in this application execution section 200b.

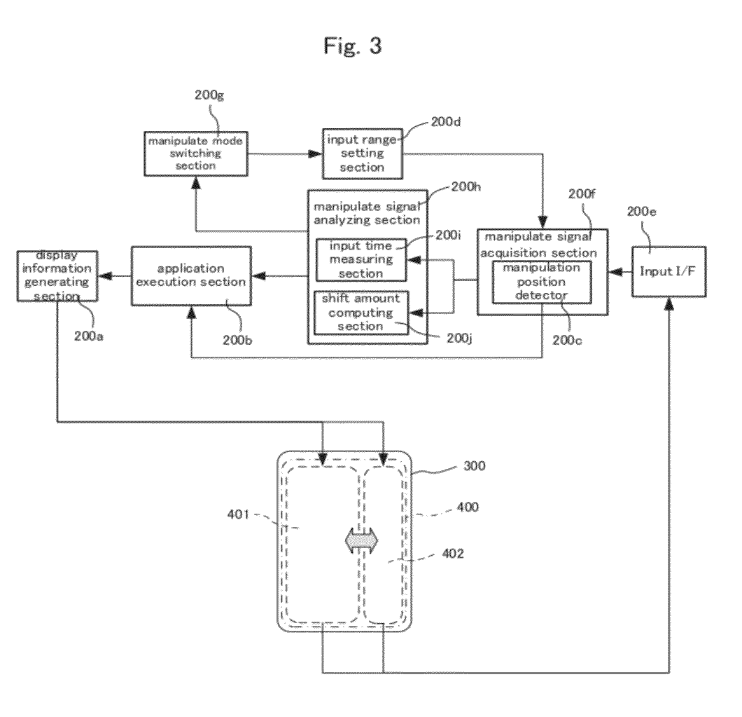

Concretely, as shown in FIG. 3, by executing an application including an input control program of the present invention in an application execution section 200b, modules, such as a display information generating section 200a, a manipulate signal acquisition section 200f, an input range setting section 200d, a manipulate signal analyzing section 200h and a manipulate mode switching section 200g are virtually built. Here, the “module” in the following explanation is constituted by hardware, such as a device and an apparatus, software with a function, or such combination, and indicates the functional unit for attaining predetermined operation.

An input interface (I/F) 200e is a module for receiving manipulate signals of the user input from the touch sensor 168, the manual operation button 166 and other manipulating devices and inputting to the manipulate signal acquisition section 200f.

The manipulate signal acquisition section 200f is a module which inputs the inputted manipulate signal into the application execution section 200b as an operating command. In detail, an input range setting determined by the input range setting section 200d and a relative position of the manipulate signal are compared, and an operating command associated with a comparison result and the manipulate signal is selected and input to the application execution section 200b.

Then, in accordance with this embodiment, the manipulate signal acquisition section 200f includes the manipulation position detector 200c. The manipulation position detector 200c is a module for detecting the coordinate position of the manipulate signals input to the touch panel 300. This coordinate point detects a coordinate point of the input position from an input coordinate position of the manipulate signals detected by the touch sensor 168.

The input range setting section 200d is a module for partitioning the input range of the manipulate signals on the touch panel 300. Within this embodiment, the manipulation position detector 200c detects a manipulated point (the coordinate position) on the touch panel 300, and the input range varies according to this detected manipulated point, other input devices, and acceleration detected by the acceleration sensor 164.

In detail, the input range setting section 200d partitions multiple input ranges 400 on the touch panel 300, and a first input range 401 and a second input range 402 are partitioned in accordance with this embodiment. At this point, the first input range 401 is an input range for displaying selectable select options by the touch manipulation as icons, and the second input range 402 is an input range for displaying a total shift amount of the icons as a gauge. Then, each of the input range detects the manipulated point on the touch panel 300 by using the manipulation position detector 200c, and the input ranges 400 are varied according to this detected manipulated point and the detected acceleration sensor 164.

In detail, within the first input range 401, it is possible to vary its displaying form, such that the icons are arranged in a spiral form as shown in FIG. 5(a), or this spiral form is arranged linearly as shown in FIG. 5(b), and arrangement of the icons can be scrolled by moving the manipulated point to a direction of the icons at each of the displaying form.

On the other hand, the gauge is displayed at the second input range 402, and icons displayed at the first input range 401 can be shifted by shifting a point on the gauge according to a scrolling manipulation for sliding a meter of this gauge. That is, this gauge shows the total shift amount of the icons as a length of the gauge, and the gauge and the icons can be interlocked that by shifting a point on this gauge, proportions, in which its point position indicates, to a full length of the gauge become proportions of a present shift amount to the total shift amount of the icons. Herewith, many icons can be scrolled by a little manipulation toward the gauge.

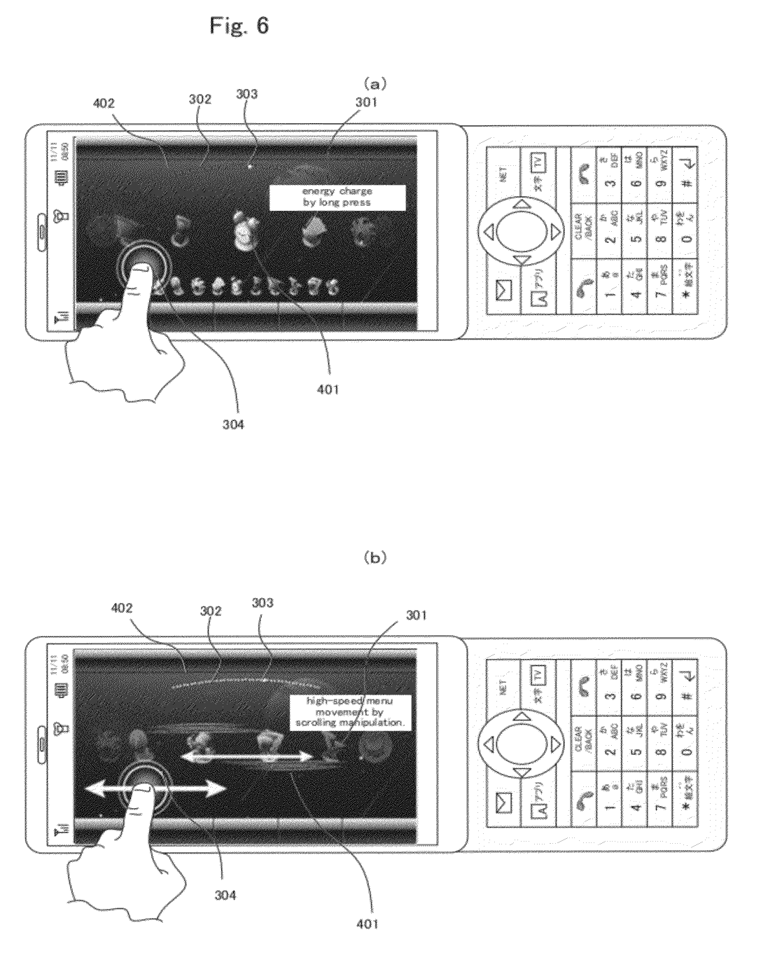

Furthermore, this input range can switch its display direction by inclination of a main body of the device detected by the acceleration sensor 164 mentioned above. Specifically, as shown in FIG. 6(a) and FIG. 6(b), the display screen automatically turns sideways when the main body of the device is horizontally inclined. In this condition of inclining sideways, as shown in FIG. 6, an icon representation of the first input range and a gauge representation of the second input range are displayed as a set, the second input range is enlarged by specified manipulations such as long pressing of the display as shown in FIG. 6(a), and the gauge manipulation can be possible on the display ranges of the icons as shown in FIG. 6(b).

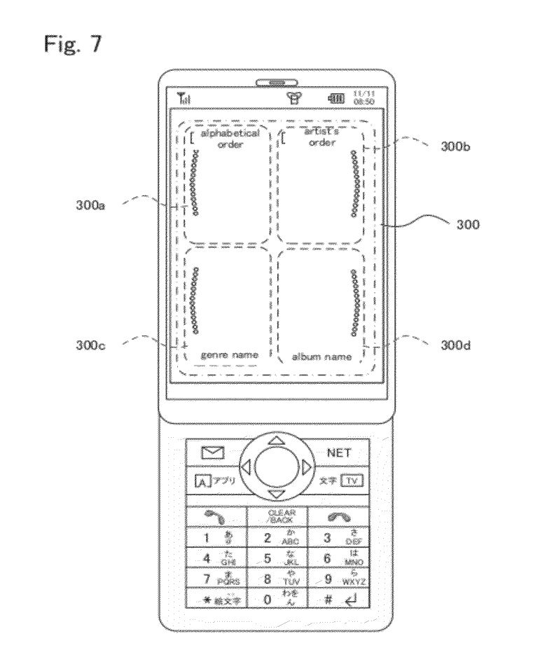

In addition, the input range setting section 200d, as shown in FIG. 7, partitions the input range into multiple split screens and includes a function for partitioning the first input range 401 and the second input range 402 as a pair at all or a part of the multiple split screens. As a result, since a combination of the icons and the gauge are many displayed within the screen, multiple interfaces corresponding to wide variety of applications can be provided at the same time for assigning respective input information and manipulation methods to each combinations.

The manipulate signal analyzing section 200h is a module for acquiring and analyzing specified manipulate signals from the manipulate signal acquisition section 200f and for transmitting analyzed signals to the application execution section 200b and the manipulate mode switching section 200g, and includes an input time measuring section 200i and a shift amount computing section 200j in accordance with this embodiment.

The input time measuring section 200i is a module for measuring an input duration at a specified coordinate position, and the shift amount computing section 200j is a module for calculating a shift amount of the coordinate position of the manipulate signals generated by the touch manipulation.

The manipulate mode switching section 200g is a module for changing a position or a size of each input range on the touch panel 300 based on a analysis result by the manipulate signal analyzing section 200h, and in accordance with this embodiment, the input range is changed when the input duration, measured by the input time measuring section 200i, becomes a specified duration or an interval.

In addition, the manipulate mode switching section 200g, which is independent from the display range of the icons and the display range of the gauge, provides functions to change positions and sizes of the first input range 401 and the second input range 402.

The display information generating section 200a is a module for generating display information (graphics and textual information) displayed on the LCD 165, and configures GUI by cooperating with the manipulate signal acquisition section 200f. This display information generating section 200a provides functions for setting a range to display the display information on the LCD 165 and partitioning the display range at the LCD 165 in to multiple display ranges. In addition, ratio of multiple display range is varied according to a relative position detected by the manipulation position detector 200c.

Moreover, in accordance with this embodiment, the display information generating section 200a displays the first input range 401 and the second input range 402 as input ranges. In the first input range 401, select options selectable by the touch manipulation are displayed as icons. On the other hand, in the second input range 402, the total shift amount of the icons is displayed as a gauge.

Furthermore, the input range setting section 200d splits the input range into multiple split screens, and also provides a function for partitioning the first input range 401 and the second input range 402 as a pair within all or a part of the multiple split screens.

In addition, the display information generating section 200a also provides a function for changing the display information according to the coordinate point (a relative position at the touch panel 300), which is detected by the manipulation position detector 200c and input the manipulate signals, and the acceleration, which is detected by the acceleration sensor 164.

The application execution section 200b is a module for executing the program and builds each above module virtually on the CPU 200. In particular, in accordance with this embodiment, it controls to shift icons according to a shift amount of the coordinate position of the manipulate signals in the first input range 401 based on an input from the manipulate signal acquisition section 200f and the manipulate signal analyzing section 200h; meanwhile, m it controls to change the gauge according to the shift amount of the coordinate position of the manipulate signals in the second input range 402. Specifically, as shown in FIG. 1, it controls to shift back and forth in a radial direction according to a rotational transfer of the coordinate position of an input signal in the first input range 401 or a manipulated variable toward the gauge in the second input range 402.

(Manipulation of Interface and Controlling Method)

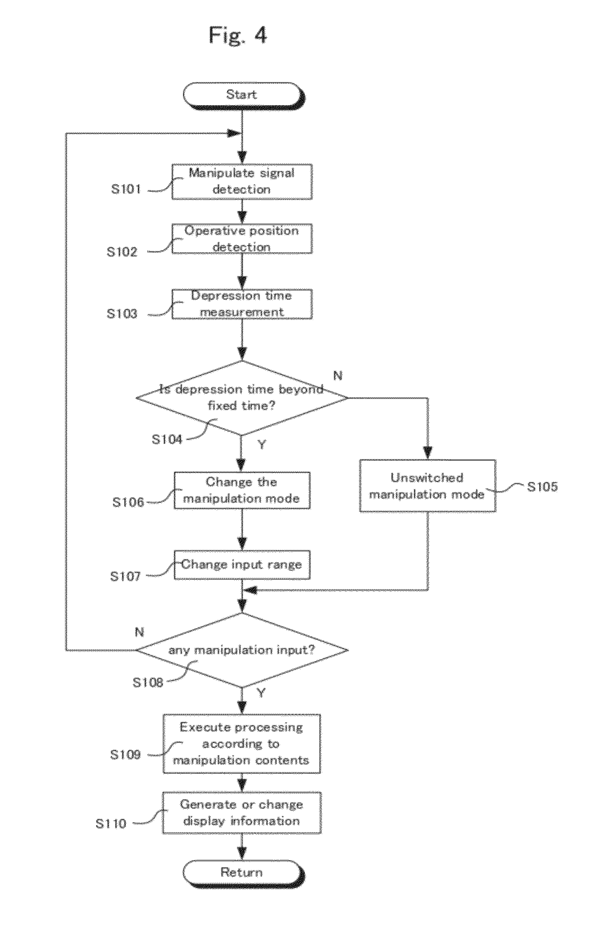

By executing the program above mentioned, manipulation of the interface and controlling method can be performed. FIG. 4 is a flowchart illustrating manipulating method of the portable communication terminal 1 of this embodiment.

The portable communication terminal 1 is provided with many features such as transmission and reception of e-mails, the Internet connectivity, camera photographing, a video or picture browser and games, and following is an explanation of an example of manipulation when the user selects either one of each feature through the touch panel 300.

In addition, the input range of the touch panel 300 includes the first input range 401 and the second input range 402 in advance.

First, the user inputs against the touch panel 300 by using a finger or a pen point, and these input manipulate signals are input to the manipulate signal acquisition section 200f through the input interface (I/F) 200e and detected as manipulate signals (S101). Then, the manipulation position detector 200c detects the coordinate position of the manipulate signals input to the touch panel 300 from this manipulate signals (S102). At this point, the manipulation position detector 200c determines from the coordinate position whether the input range is the first input range or the second input range. Furthermore, the manipulate signal acquisition section 200f transmits acquired manipulate signals to the manipulate signal analyzing section 200h.

The manipulate signals received from the manipulate signal acquisition section 200f is input to the input time measuring section 200i, and the input time measuring section 200i measures the input duration in the specified coordinate position (S103). At this point, when the input duration is in a certain period of time (“N” in S104), a manipulation mode is unswitched (S105), and a presence or absence of a manipulation input is determined without changing areas of the first input range 401 and the second input range 402 (S108).

When the manipulation input is absent (“N” in S108), the process is on standby until next manipulation input is operated and the manipulation signals are detected. When the manipulation input is present (“Y” in S108), a process is executed according to manipulation contents, such as a manipulation location of its manipulation input and a shift amount, and the display information generating section 200a generates and changes display information, such as moving icons and displaying applications (S110).

On the other hand, when the input duration is greater than a certain period of time (“Y” in S104), the manipulate mode switching section 200g changes to the manipulation mode (S106) and changes all of the input ranges to the second input range (S107). Then, the application execution section 200b determines presence or absence of input of the manipulate signals (manipulation input) (S108).

At this point, when the manipulation input is absent (“N” in S108), the process is on standby until next manipulation input is operated and the manipulation signals are detected. When the manipulation input is present (“Y” in S108), a process is executed according to manipulation contents, such as a manipulation location of its manipulation input and a shift amount. Since the manipulation mode is changed, all of the input ranges 400 are the second input range 402 now, and the manipulation contents based on the second input range is executed when either location is manipulated (S109). Then, the display information generating section 200a generates and changes the display information, such as quickly moving icons (S110).

(The Operation and Effects)

According to the present embodiment explained above, since the input range is partitioned in the touch panel, the input information and the manipulation method can be partitioned according to the partitions, and the areas of the touch panel can be effectively utilized. At that time, by long pressing in the partitions of either the first input range 401 or the second input range 402, it is possible to change locations or areas of the input range, enlarges the input range of one side, and the input information and the manipulation method toward enlarged ranges can be given priority.

As a result, according to the present embodiment, within an information terminal, such as a cellular phone etc., an input range of a touch panel 300 can be controlled according to manipulation contents of a user, an erroneous selection of select options by the touch manipulation can be avoided, and operability can be improved.

### REFERENCE SIGNS LIST

1—Portable communication terminal
100—Body
164—Acceleration sensor
165—LCD
166—Manual operation button
167—LED
168—Touch sensor
200—CPU
200a—Display information generating section
200b—Application execution section
200c—Manipulation position detector
200d—Input range setting section
200e—Input interface
200f—Manipulate signal acquisition section
200g—Manipulate mode switching section
200h—manipulate signal analyzing section
200i—Input time measuring section
200j—Shift amount computing section
300—Touch panel
400—Input range
401—First input range
402—Second input range
403—Focus
404—Focus

1. An information terminal comprising:
a touch panel for inputting manipulate signals with a pressure of a touch manipulation;
a manipulate signal acquisition section for detecting a coordinate position of the manipulate signals input to the touch panel;
an input range setting section for partitioning multiple input ranges on the touch panel;
a manipulate signal analyzing section for acquiring and analyzing a specified manipulate signal; and
a manipulate mode switching section for changing a position or size of each of the input range on the touch panel based on a analysis result by the manipulate signal analyzing section.

2. The information terminal as claimed in claim 1,
wherein the manipulate signal analyzing section comprising an input time for measuring section measuring an input duration at a specified coordinate position; and
wherein the manipulate mode switching section changes the input range when an input duration measured by the input time measuring section becomes a specified duration or interval.

3. The information terminal as claimed in claim 1, wherein
the input range setting section partitions a first input range and a second input range;
the first input range displays selectable select options as icons by touch manipulation and moving the icons according to a shift amount of the coordinate position of the manipulate signals at the first input range;
the second input range displays a total shift amount of the icons as a gauge, and the gauge is changed according to a shift amount of the coordinate position of the manipulate signals in the second input range; and
the manipulate mode switching section is independent from a display range of the gauge and a display range of the icons and changes a position and size of the first input range and the second input range.

4. The information terminal as claimed in claim 3, wherein the input range setting section splits the input range into multiple split screens, and partitions the first input range and the second input range as a pair within all or a part of the multiple split screens.

5. The information terminal as claimed in claim 3, wherein the icons are arrayed in a spiral form, and shifted back and forth in a radial direction in accordance with a rotational transfer of the coordinate position of an input signal in the first input range or in accordance with a manipulated variable against the gauge in the second input range.

6. The information terminal as claimed in claim 5, wherein
the select options form a virtual hierarchical structure according to its type, a link is formed between the select options according to a mutual relevance, and it is possible to be shifted between hierarchies by following the link; and
the icons are arranged in the spiral form according to the (virtual) hierarchical structure or the link, and color-coded by hierarchies or coded to be displayed.

7. An input control program for controlling input of manipulate signals against a touch panel within an information terminal comprising the touch panel inputting the manipulate signals with a pressure of a touch manipulation, the input control program causing the information terminal to perform:
an input range setting step for partitioning multiple input ranges onto the touch panel;
a manipulate signal acquisition step for detecting a coordinate position of manipulate signals input to the touch panel;
a manipulate signal analyzing step for acquiring and analyzing specified manipulate signals; and
a manipulate mode switching step for changing a position or a size of each of the input range on the touch panel based on a analysis result by the manipulate signal acquisition step.

8. The input control program as claimed in claim 7, wherein
the manipulate signal analyzing step measures an input duration in the specified coordinate position; and
the manipulate mode switching step changes the input range when the input duration measured at the manipulate signal analyzing step becomes a specified duration or interval.

9. The input control program as claimed in claim 7, wherein
the input range setting step partitions a first input range and a second input range;
the first input range displays selectable select options by a touch manipulation as icons, and the icons are shifted according to a shift amount of the coordinate position of the manipulate signals in the first input range;
the second input range displays a total shift amount of the icons as a gauge, and the gauge is changed according to a shift amount of the coordinate position of the manipulate signals in the second input range; and
the manipulate mode switching step is independent from a display range of the gauge and a display range of the icons and changes a position and size of the first input range and the second input range.

10. The input control program as claimed in claim 9, wherein
the input range setting step splits the input range into multiple split screens and partitioning the first input range and the second input range as a pair within all or a part of the multiple split screens.

11. The input control program as claimed in claim 9, wherein
the icons are arrayed in a spiral form, and shifted back and forth in a radial direction in accordance with a rotational transfer of the coordinate position of an input signal in the first input range or in accordance with a manipulated variable against the gauge in the second input range.

12. The input control program as claimed in claim 11, wherein
the select options form a virtual hierarchical structure according to its type, a link is formed between the select options according to a mutual relevance, and it is possible to be shifted between hierarchies by following the link; and
the icons are arranged in the spiral form according to the (virtual) hierarchical structure or the link, and color-coded by hierarchies or coded to be displayed.
